(19) United States
(12) Patent Application Publication
(10) Pub. No.: US 2004/0264808 A1
(43) Pub. Date: Dec. 30, 2004

(54) Method of and apparatus for correcting image alignment errors

(75) Inventor: Young-sun Chun, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics, Co., Ltd., Suwon-Si (KR)

(21) Appl. No.: 10/771,408

(22) Filed: Feb. 5, 2004

(30) Foreign Application Priority Data
Mar. 7, 2003 (KR) 2003-14476

(51) Int. Cl. G06K 9/32

(52) U.S. Cl. 382/294

(57) ABSTRACT

A method of correcting image alignment errors including a printing instruction unit and a printing unit printing a reference line, a first comparison line, and a second comparison line, an alignment error calculation unit calculating image alignment errors by measuring a distance between the reference line and the first comparison line and a distance between the reference line and the second comparison line, and a control value calculation unit calculating a predetermined control value correcting the calculated image alignment errors.

### CROSS-REFERENCE TO RELATED APPLICATIONS

This application claims the priority of Korean Patent Application No. 2003-14476, filed on Mar. 7, 2003, in the Korean Intellectual Property Office, the disclosure of which is incorporated herein in its entirety by reference.

### BACKGROUND OF THE INVENTION

1. Field of the Invention

The present invention relates to image alignment in an ink-jet printer, and more particularly, to a method of and apparatus for automatically correcting image alignment errors by using a control value.

2. Description of the Related Art

In general, in an ink-jet printer, which prints an entire image by combining several images printed according to different printing modes, errors may occur in the image alignment when the image is printed. These errors cause low printing quality, and they are due to factors such as nonuniformity of traveling of an ink-jet cartridge and differences in the position of an ink-jet cartridge due to ink colors. In the related art, a plurality of test marks are provided such that a user can check in advance the alignment state of images to correct the errors.

FIGS. 1A and 1B show a plurality of printed test marks for checking the image alignment errors and correcting the errors. In the related art, in order to correct the errors in the image alignment, a plurality of test marks are printed. The test marks are divided into test mark patterns for checking an alignment state on a horizontal axis, as shown in FIG. 1A, and test mark patterns for checking an alignment state on a vertical axis, as shown in FIG. 1 B. In general, several tens of test marks are provided to check an alignment state on the horizontal axis or vertical axis. A user selects a test mark, an alignment state of which is the highest, from the plurality of printed test marks. Then, an ink-jet printer performs a correction operation of an image, which is the most suitable for image printing, using a correction value selected by the user. In the test mark patterns of FIG. 1A, the alignment state of a test mark \mathring{5} is the highest, and in the test mark patterns of FIG. 1B, the alignment state of a test mark \mathring{4} is the highest. Thus, the user selects the test marks \mathring{4} and \mathring{5} such that a correction operation is properly performed.

However, in the related art, the user should check the plurality of test marks to detect the alignment state of the test marks. Since this operation is performed with the naked eye, it is time consuming and the user easily gets tired. Also, improper test marks may be selected by the user. In addition, even though the alignment state of the test marks is automatically measured, there may be a plurality of test marks improperly selected by the user. Thus, a large computational capacity is needed to measure the alignment state of the test marks.

In addition, the ink-jet printer which automatically detects a pattern, an alignment state of which is the highest, from the plurality of test marks improperly selected by the user, cannot easily perform local correction when, due to the large area occupied by the plurality of test marks, a correction value frequently varies throughout a given area.

### SUMMARY OF THE INVENTION

The present invention provides a method of correcting image alignment errors, by which errors in the image alignment are measured using only three test marks and image alignment errors are automatically corrected using the measured errors in the image alignment and a control value applied thereto.

The present invention also provides an apparatus for correcting image alignment errors, by which errors in the image alignment are measured using only three test marks and image alignment errors are automatically corrected using the measured errors in the image alignment and a control value applied thereto.

According to an aspect of the present invention, there is provided a method of correcting image alignment errors in an ink-jet printer which has a printhead and performs a printing operation by ejecting ink from the printhead according to a variety of printing modes, the method includes printing a reference line, a first comparison line, and a second comparison line, calculating image alignment errors by measuring a distance between the reference line and the first comparison line and a distance between the reference line and the second comparison line, and calculating a predetermined control value for correcting the calculated image alignment errors.

According to another aspect of the present invention, there is provided an apparatus for correcting image alignment errors in an ink-jet printer which has a printhead and performs a printing operation by ejecting ink from the printhead according to a variety of printing modes, the apparatus includes a printing instruction unit, to instruct a printing unit to print a first reference line, a first comparison line, and a second comparison line and outputs an instruction result as an instruction signal, the printing unit, which prints the reference line, the first comparison line, and the second comparison line in response to the instruction signal, an alignment error calculation unit, which calculates alignment errors by measuring a distance between the reference line and the first comparison line and a distance between the reference line and the second comparison line, and a control value calculation unit, which calculates a predetermined control value for correcting the calculated image alignment errors.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments taken in conjunction with the accompanying drawings in which:

FIGS. 1A and 1B show conventional embodiments in which a plurality of test marks for checking the image alignment errors and correcting the errors are printed;

FIG. 2 is a flowchart illustrating a method of correcting image alignment errors according to an embodiment of the present invention;

FIG. 3 is a flowchart illustrating operation 10 shown in FIG. 2, according to an embodiment of the present invention;

FIG. 4 illustrates a state where a vertical reference line, a first vertical comparison line, and a second vertical comparison line are printed, shown in FIG. 3, according to the present invention;

FIG. 5 is a flowchart illustrating operation 10 shown in FIG. 2, according to an embodiment of the present invention;

FIG. 6 illustrates a state where a horizontal reference line, a first horizontal comparison line, and a second horizontal comparison line are printed, shown in FIG. 5, according to the present invention;

FIG. 7 is a flowchart illustrating operation 12 shown in FIG. 2, according to an embodiment of the present invention;

FIG. 8 is a flowchart illustrating operation 40 shown in FIG. 7, according to an embodiment of the present invention;

FIG. 9 is a flowchart illustrating operation 12 shown in FIG. 2, according to another embodiment of the present invention;

FIG. 10 is a flowchart illustrating operation 60 shown in FIG. 9, according to an embodiment of the present invention;

FIG. 11 is a flowchart illustrating operation 14 shown in FIG. 2, according to an embodiment of the present invention;

FIG. 12 is a flowchart illustrating operation 14 shown in FIG. 2, according to another embodiment of the present invention;

FIG. 13 is a block diagram illustrating a structure of an apparatus for correcting image alignment errors according to an embodiment of the present invention;

FIG. 14 is a block diagram illustrating a printing instruction unit shown in FIG. 13, according to an embodiment of the present invention;

FIG. 15 is a block diagram illustrating an alignment error calculation unit shown in FIG. 13, according to an embodiment of the present invention;

FIG. 16 is a block diagram illustrating an actual distance measurement portion shown in FIG. 15, according to an embodiment of the present invention; and

FIG. 17 is a block diagram illustrating a control value calculation unit shown in FIG. 13, according to an embodiment of the present invention.

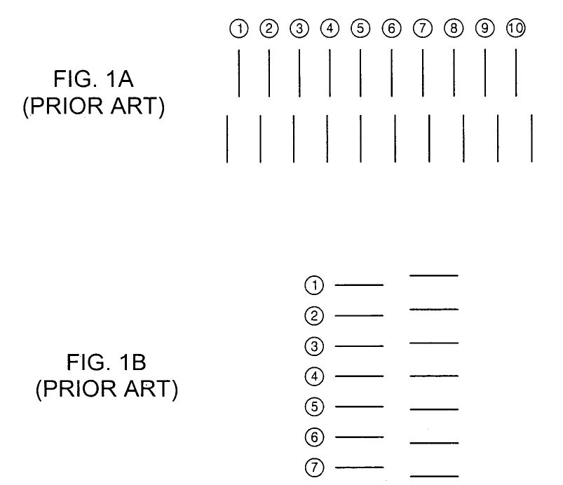

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

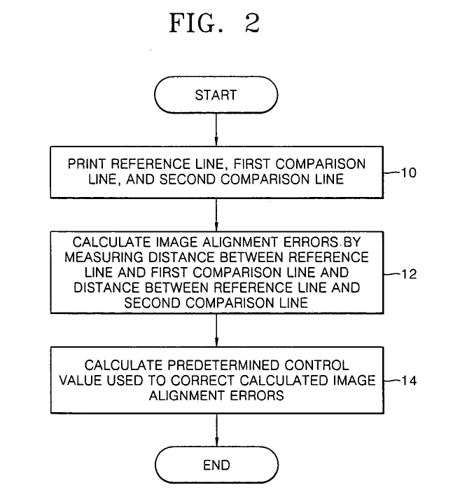

FIG. 2 is a flowchart illustrating a method of correcting image alignment errors according to an embodiment of the present invention. The method of correcting image alignment errors comprises operations 10 through 14 of calculating a predetermined control value for correcting image alignment errors from a printed reference line and first and second comparison lines.

In operation 10, the reference line, the first comparison line, and the second comparison lines are printed.

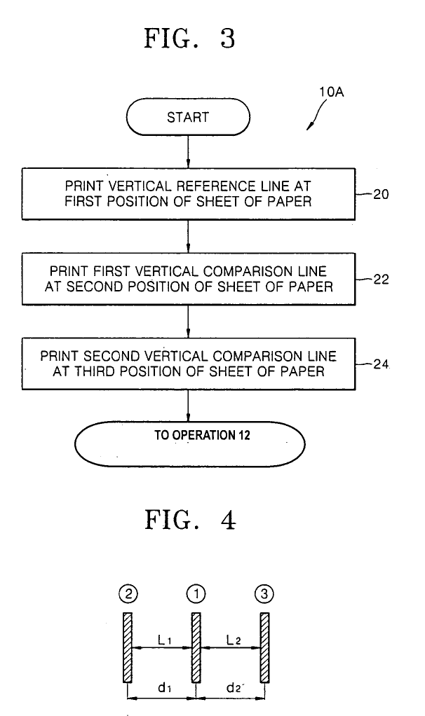

FIG. 3 is a flowchart illustrating operation 10 shown in FIG. 2, according to an embodiment 10A of the present invention. The embodiment 10A includes operations 20 through 24 of printing a vertical reference line, a first vertical comparison line, and a second vertical comparison line at a first position, a second position, and a third position on a sheet of paper, respectively.

FIG. 4 illustrates a state where the vertical reference line, the first vertical comparison line, and the second vertical comparison line are printed, based on the flowchart of FIG. 3.

In operation 20, the vertical reference line is printed at a first position on a sheet of paper by a first control value used to control ink ejection according to a first printing mode. The first printing mode belongs to one printing mode of a variety of printing modes. The variety of printing modes includes modes regarding a moving speed of a printhead, a moving direction of the printhead, and ink colors. The first control value is used to control ink ejection of an ink-jet printer, such as a starting point of the printhead, an ink dropping time or selection of nozzles of the printhead. The vertical reference line is a line printed to check an alignment state on a horizontal axis and a reference for vertical comparison lines which will be described later. The first position corresponds to an arbitrary position on the sheet of paper. The vertical reference line is printed at the first position on the sheet paper by controlling the first control value. \mathring{1} of FIG. 4 indicates a state in which the vertical reference line is printed.

After operation 20, in operation 22, the first vertical comparison line is printed at the second position on the sheet of paper separated from the vertical reference line printed at the first position by a first predetermined distance that is virtually set, by a second control value used to control ink ejection according to a second printing mode. The second printing mode also belongs to one printing mode of the variety of printing modes. Like the first control value, the second control value is also used to control ink ejection of an ink-jet printer, such as a starting point of the printhead, an ink dropping time or selection of nozzles of the printhead. The first predetermined distance refers to a virtual distance from the vertical reference line assuming that there are no image alignment errors of the ink-jet printer. The second position is separated from the vertical reference line by the first predetermined distance. The first vertical comparison line is printed at the second position of the sheet of paper by controlling the second control value. The first vertical comparison line is a line printed to check an alignment state on a horizontal axis and is used to compare the above-described vertical reference line with a separated distance. When the first predetermined distance is L₁, \mathring{2} of FIG. 4 indicates a state where the first vertical comparison line, separated from the vertical reference line by L₁, is printed.

The first vertical comparison line may be printed in the same direction as the direction of the above-described vertical reference line but may be printed in a direction opposite to the direction of the vertical reference line. In other words, if the vertical reference line is printed when the printhead is moved from left to right, the first vertical comparison line may be printed when the printhead is moved from left to right or from right to left.

After operation 22, in operation 24, the second vertical comparison line is printed at the third position on the sheet of paper separated from the vertical reference line printed at the first position by a second predetermined distance that is virtually set, by a third control value used to control ink ejection according to a second printing mode. Like the first control value, the third control value is also used to control ink ejection of an ink-jet printer, such as a starting point of the printhead, an ink dropping time or selection of nozzles of the printhead. The second predetermined distance refers to a virtual distance from the vertical reference line assuming that there are no image alignment errors of the ink-jet printer. The third position is separated from the vertical reference line by the second predetermined distance. The second vertical comparison line is printed at the third position of the sheet of paper by controlling the third control value. The second vertical comparison line is a line printed to check an alignment state on a horizontal axis and is used to compare the above-described vertical reference line with a separated distance. When the second predetermined distance is L₂, \mathring{3} of FIG. 4 indicates a state where the second vertical comparison line, separated from the vertical reference line by L₂, is printed.

The second vertical comparison line may be printed in the same direction as the direction of the above-described vertical reference line but may be printed in a direction opposite to the direction of the vertical reference line. In other words, if the vertical reference line is printed when the printhead is moved from left to right, the second vertical comparison line may be printed when the printhead is moved from left to right or from right to left.

Meanwhile, the first vertical comparison line and the second vertical comparison line may be printed on the left or right side of the vertical reference line or may be printed on both left and right sides of the vertical reference line.

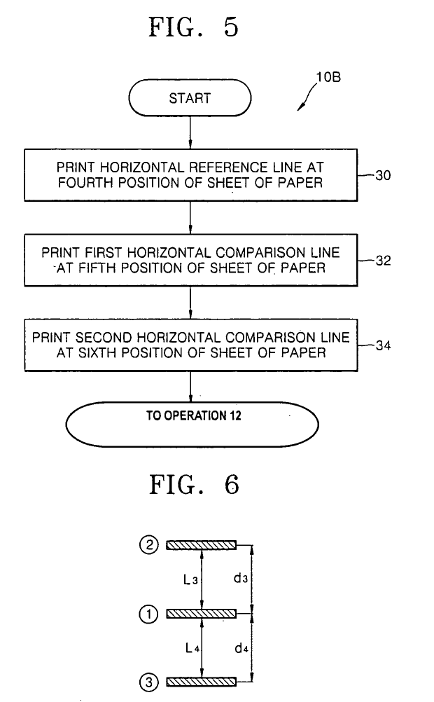

FIG. 5 is a flowchart illustrating operation 10 shown in FIG. 2, according to an embodiment 10B of the present invention. The embodiment 10B includes operations 30 through 34 of printing a horizontal reference line, a first horizontal comparison line, and a second horizontal comparison line at a fourth position, a fifth position, and a sixth position on a sheet of paper, respectively.

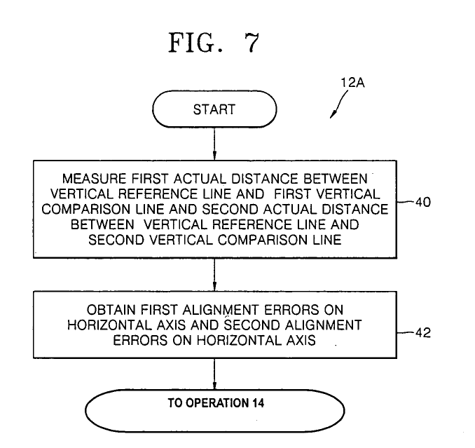

FIG. 6 illustrates a state where the horizontal reference line, the first horizontal comparison line, and the second horizontal comparison line are printed, based on the flowchart shown in FIG. 5.

First, in operation 30, the horizontal reference line is printed at a fourth position of a sheet of paper by a fourth control value used to control ink ejection according to a third printing mode. The third printing mode also belongs to one printing mode of a variety of printing modes. The fourth control value is used to control ink ejection of an ink-jet printer, such as a starting point of the printhead, an ink dropping time or selection of nozzles of the printhead. The horizontal reference line is a line printed to check an alignment state on a vertical axis and a reference for horizontal comparison lines which will be described later. The fourth position corresponds to an arbitrary position on the sheet of paper. The horizontal reference line is printed at the fourth position of the sheet of paper by controlling the fourth control value. \mathring{1} of FIG. 6 indicates a state in which the horizontal reference line is printed.

After operation 30, in operation 32, the first horizontal comparison line is printed at the fifth position on the sheet of paper separated from the horizontal reference line printed at the fourth position by a third predetermined distance that is virtually set, by a fifth control value used to control ink ejection according to a fourth printing mode. The fourth printing mode also belongs to one printing mode of the variety of printing modes. Like the fourth control value, the fifth control value is also used to control ink ejection of an ink-jet printer, such as a starting point of the printhead, an ink dropping time or selection of nozzles of the printhead. The third predetermined distance refers to a virtual distance from the horizontal reference line assuming that there are no image alignment errors of the ink-jet printer. The fifth position is separated from the horizontal reference line by the third predetermined distance. The first horizontal comparison line is printed at the fifth position of the sheet of paper by controlling the fifth control value. The first horizontal comparison line is a line printed to check an alignment state on a vertical axis and is used to compare the above-described horizontal reference line with a separated distance. When the third predetermined distance is L₃, \mathring{2} of FIG. 6 indicates a state where the first horizontal comparison line, separated from the horizontal reference line by L₃, is printed.

The first horizontal comparison line may be printed in the same direction as the direction of the above-described horizontal reference line but may be printed in a direction opposite to the direction of the horizontal reference line. Thus, by arranging a printhead for printing the horizontal reference line and a printhead for printing the first horizontal comparison line separately, an effect on alignment errors on a vertical axis of different printheads can be seen.

After operation 32, in operation 34, the second horizontal comparison line is printed at the sixth position on the sheet of paper separated from the horizontal reference line printed at the fourth position by a fourth predetermined distance that is virtually set, by a sixth control value used to control ink ejection according to a fourth printing mode. Like the fourth control value, the sixth control value is also used to control ink ejection of an ink-jet printer, such as a starting point of the printhead, an ink dropping time or selection of nozzles of the printhead. The fourth predetermined distance refers to a virtual distance from the vertical reference line assuming that there are no image alignment errors of the ink-jet printer. The sixth position is separated from the horizontal reference line by the fourth predetermined distance. The second horizontal comparison line is printed at the third position of the sheet of paper by controlling the sixth control value. The second horizontal comparison line is a line printed to check an alignment state on a vertical axis and is used to compare the above-described horizontal reference line with a separated distance. When the fourth predetermined distance is L₄, \mathring{3} of FIG. 6 indicates a state where the second horizontal comparison line, separated from the horizontal reference line by L₄, is printed.

The second horizontal comparison line may be printed in the same direction as the direction of the above-described horizontal reference line but may be printed in a direction opposite to the direction of the horizontal reference line. Thus, by arranging a printhead for printing the horizontal reference line and a printhead for printing the first horizontal comparison line separately, an effect on alignment errors on a vertical axis of different printheads can be seen.

Meanwhile, the first horizontal comparison line and the second horizontal comparison line may be printed on a top or bottom of the horizontal reference line or may be printed on both the top and bottom of the horizontal reference line.

After operation 10, in operation 12, image alignment errors are calculated by measuring a distance between the reference line and the first comparison line and a distance between the reference line and the second comparison line.

FIG. 7 is a flowchart illustrating operation 12 shown in FIG. 2, according to an embodiment 12A of the present invention. The embodiment 12A includes operations 40 and 42 of obtaining first and second alignment errors on a horizontal axis using measured first and second actual distances.

First, in operation 40, a first actual distance between a vertical reference line and a first vertical comparison line and a second actual distance between the vertical reference line and a second vertical comparison line are measured. In FIG. 4, d₁ and d₂ correspond to the first actual distance and the second actual distance.

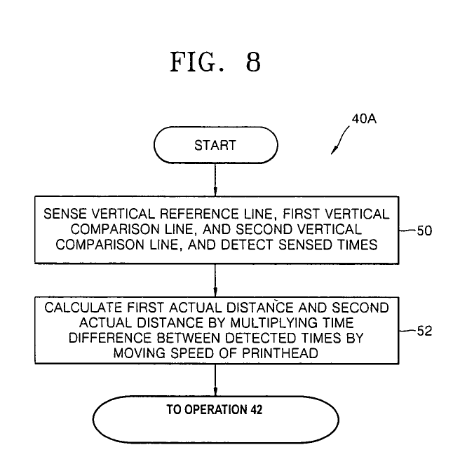

FIG. 8 is a flowchart illustrating operation 40 shown in FIG. 7, according to an embodiment 40A of the present invention. The embodiment 40A includes operations 50 and 52 of detecting times where the first vertical comparison line and the second vertical comparison line are sensed, and calculating the first actual distance and the second actual distance by multiplying a time difference between the detected times by a moving speed on a horizontal axis of a printhead.

First, in operation 50, the vertical reference line, the first vertical comparison line, and the second vertical comparison line are sensed, and corresponding sensing times are detected. For example, as shown in FIG. 4, the first printed vertical comparison line is sensed and a time t₁, when the first vertical comparison line is sensed is detected, the printed vertical reference line is sensed and a time t₂, when the vertical reference line is sensed is detected and the second printed vertical comparison line is sensed and a time t₃, where the second vertical comparison line is sensed is detected.

After operation 50, in operation 52, the first actual distance is calculated by multiplying a time difference between the time when the sensed vertical reference line is detected and the time when the first sensed vertical comparison line is detected, by a moving speed on a horizontal axis of a printhead, or the second actual distance is calculated by multiplying a time difference between the time when the sensed vertical reference line is detected and the time when the second sensed vertical comparison line is detected, by the moving speed on the horizontal axis of the printhead. Thus, if a time difference between the time t₂ when the vertical reference line is detected and the time t₁ when the first vertical comparison line is detected is multiplied by the moving speed on the horizontal axis of the printhead for printing the first vertical comparison line, the first actual distance which corresponds to an actual distance between the vertical reference line and the first vertical comparison line, can be calculated. In addition, if a time difference between the time t₂ when the vertical reference line is detected and the time t₃ when the second vertical comparison line is detected is multiplied by the moving speed on the horizontal axis of the printhead for printing the second vertical comparison line, the second actual distance which corresponds to an actual distance between the vertical reference line and the second vertical comparison line, can be calculated.

After operation 40, in operation 42 of FIG. 7, first alignment errors on a horizontal axis are obtained by subtracting a first predetermined distance from the first actual distance, and second alignment errors on the horizontal axis are obtained by subtracting a second predetermined distance from the second actual distance. For example, assuming that y₁ is first alignment errors on a horizontal axis, d₁ is a first actual distance and L₁ is a first predetermined distance, the first alignment errors on the horizontal axis can be obtained by Equation 1.

y₁d₁−L₁ (1)

In addition, assuming that y₂ is second alignment errors on a horizontal axis, d₂ is a second actual distance and L₂ is a second predetermined distance, the second alignment errors on the horizontal axis can be obtained by Equation 2.

y₂=d₂−L₂ (2)

If there are no image alignment errors, an actual distance between the vertical reference line and the first vertical comparison line should be the first predetermined distance, and an actual distance between the vertical reference line and the second vertical comparison line should be the second predetermined distance. However, as described in the background, due to factors such as nonuniformity of traveling of an ink-jet cartridge and difference in the position of an ink-jet cartridge due to ink colors, errors occur in the image alignment. Thus, by subtracting the first predetermined distance from the first actual distance, the first alignment errors on the horizontal axis can be obtained. In addition, by subtracting the second predetermined distance from the second actual distance, the second alignment errors on the horizontal axis can be obtained.

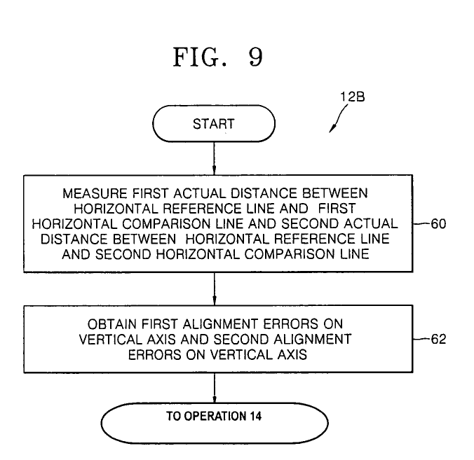

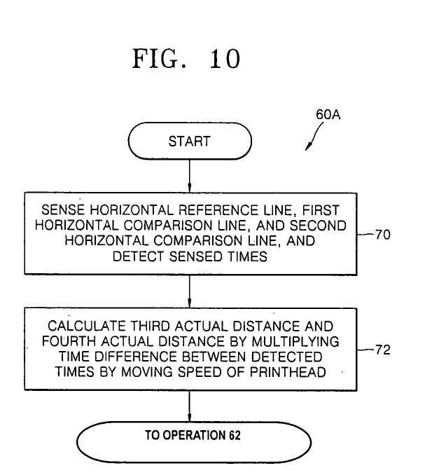

FIG. 9 is a flowchart illustrating operation 12 shown in FIG. 2, according to another embodiment 12B of the present invention. The embodiment 12B includes operations 60 and 62 of obtaining first and second alignment errors on a vertical axis using measured third and fourth actual distances.

First, in operation 60, a third actual distance between a horizontal reference line and a first horizontal comparison line and a fourth actual distance between the horizontal reference line and a second horizontal comparison line are measured. In FIG. 6, d₃ and d₄ correspond to the first actual distance and the second actual distance.

FIG. 10 is a flowchart illustrating operation 60 shown in FIG. 9, according to an embodiment 60A of the present invention. The embodiment 60A includes operations 70 and 72 of detecting times when the first horizontal comparison line and the second horizontal comparison line are sensed, and calculating the third actual distance and the fourth actual distance by multiplying a time difference between the detected times by a moving speed on a vertical axis of a printhead.

First, in operation 70, the horizontal reference line, the first horizontal comparison line, and the second horizontal comparison line are sensed, and the sensing times are detected. For example, as shown in FIG. 6, the first printed horizontal comparison line is sensed and a time t₄ when the first horizontal comparison line is sensed is detected, the printed horizontal reference line is sensed and a time t₅ when the horizontal reference line is sensed is detected, the second printed horizontal comparison line is sensed and a time t₆ when the second horizontal comparison line is sensed is detected.

After operation 70, in operation 72, the third actual distance is calculated by multiplying a time difference between the time when the sensed horizontal reference line is detected and the time when the first sensed horizontal comparison line is detected, by a moving speed on a vertical axis of a printhead, or the second actual distance is calculated by multiplying a time difference between the time when the sensed horizontal reference line is detected and the time when the second sensed horizontal comparison line is detected, by the moving speed on the vertical axis of the printhead. If a time difference between the time t₅, when the horizontal reference line is detected, and the time t₄, when the first horizontal comparison line is detected, is multiplied by the moving speed on the vertical axis of the printhead printing the first horizontal comparison line, the third actual distance which corresponds to an actual distance between the horizontal reference line and the first horizontal comparison line, can be calculated. In addition, if a time difference between the time t₅, when the horizontal reference line is detected, and the time t₆, when the second horizontal comparison line is detected, is multiplied by the moving speed on the vertical axis of the printhead printing the second horizontal comparison line, the fourth actual distance which corresponds to an actual distance between the horizontal reference line and the second horizontal comparison line, can be calculated.

After operation 60, in operation 62, first alignment errors on a vertical axis are obtained by subtracting a third predetermined distance from the third actual distance, and second alignment errors on the vertical axis are obtained by subtracting a fourth predetermined distance from the fourth actual distance. For example, assuming that y₃ is first alignment error on a vertical axis, d₃ is a third actual distance and L₃ is a third predetermined distance, the first alignment error on the vertical axis can be obtained by Equation 3.

y₃=d₃−L₃ (3)

In addition, assuming that y₄ is a second alignment error on a vertical axis, d₄ is a fourth actual distance and L₄ is a fourth predetermined distance, the second alignment error on the vertical axis can be obtained by Equation 4.

y₄=d₄−L₄ (4)

If there are no image alignment errors, an actual distance between the horizontal reference line and the first horizontal comparison line should be the third predetermined distance, and an actual distance between the horizontal reference line and the second horizontal comparison line should be the fourth predetermined distance. However, due to the above-described reasons, errors occur in the image alignment. Thus, by subtracting the third predetermined distance from the third actual distance, the first alignment error on the vertical axis can be obtained. In addition, by subtracting the fourth predetermined distance from the fourth actual distance, the second alignment error on the vertical axis can be obtained.

After operation 12, in operation 14 of FIG. 2, a predetermined control value used to correct the calculated image alignment errors is calculated. The predetermined control value is used to control ink ejection of an ink-jet printer, such as a starting point of the printhead, an ink dropping time or selection of nozzles of the printhead.

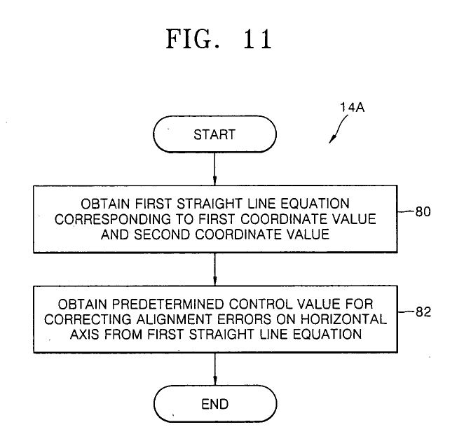

FIG. 11 is a flowchart illustrating operation 14 shown in FIG. 2, according to an embodiment 14A of the present invention. The embodiment 14A includes operations 80 and 82 of obtaining a predetermined control value from a first straight line equation.

First, in operation 80, the first straight line equation in which a second control value and first alignment error on a horizontal axis are used as a first coordinate value (second control value, first alignment error on the horizontal axis) and a third control value and second alignment error on the horizontal axis are used as a second coordinate value (third control value, second alignment error on the horizontal axis) is obtained.

For example, assuming that the second control value is x₁, the first alignment error on the horizontal axis is y₁, the third control value is x₂ and the second alignment error on the horizontal axis is y₂, the first straight line equation can be obtained by Equation 5.

y=(y₂−y₁) (x−x₁)/(x₂−x₁)+y₁=(y₂−y₁) (x−x₂)/(x₂−x₁)+y₂ (5)

where x is a predetermined control value, and y are alignment errors on a horizontal axis according to a variation of x.

Each coordinate of the first coordinate value (x₁,y₁) includes the second control value and the first alignment error on the horizontal axis, and each coordinate of the second coordinate value (x₂,y₂) includes the third control value and the second alignment error on the horizontal axis. In other words, the first straight line equation is a straight line equation which connects the first coordinate value (x₁,y₁) and the second coordinate value (x₂,y₂) indicating two points.

After operation 80, in operation 82, a predetermined control value to correct image alignment errors on a horizontal axis by controlling ink ejection is obtained from the first straight line equation.

For example, when y equals 0 so that the alignment errors on the horizontal axis do not occur, x corresponding to the predetermined control value from the above-described Equation 5 can be obtained by Equation 6.

x=(x₁×y₂−x₂×y₁)/(y₂−y₁) (6)

In other words, x corresponding to no alignment errors on the horizontal axis (y=0) becomes a predetermined control value for correcting alignment errors on the horizontal axis. Specifically, the predetermined control value can be used to control ink ejection by adjusting a starting point of a printhead, an ink dropping time or selection of nozzles of the printhead.

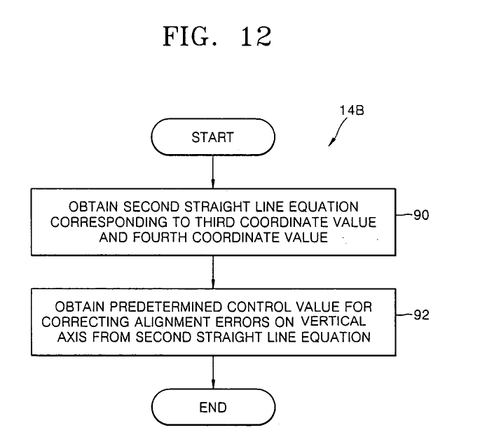

FIG. 12 is a flowchart illustrating operation 14 shown in FIG. 2, according to another embodiment 14B of the present invention. The embodiment 14B includes operations 90 and 92 of obtaining a predetermined control value from a second straight line equation.

First, in operation 90, the second straight line equation in which a fifth control value and first alignment error on a vertical axis are used as a third coordinate value (fifth control value, first alignment error on the vertical axis) and a sixth control value and second alignment error on the vertical axis are used as a fourth coordinate value (sixth control value, second alignment error on the vertical axis) is obtained.

For example, assuming that the fifth control value is x₃, the first alignment error on the vertical axis is y₃, the sixth control value is x₄ and the second alignment error on the vertical axis is y₄, the second straight line equation can be obtained by Equation 7.

y=(y₄−y₃) (x−x₃)/(x₄−x₃)+y₃=(y₄−y₃) (x−x₄)/(x₄−x₃)+y₄ (7)

where x is a predetermined control value for controlling the movement of the printhead, and y are alignment errors on a vertical axis according to a variation of x.

Each coordinate of the first coordinate value (x₃,y₃) includes the fifth control value and the first alignment error on the vertical axis, and each coordinate of the fourth coordinate value (x₄,y₄) includes the sixth control value and the second alignment error on the vertical axis. In other words, the second straight line equation is a straight line equation which connects the third coordinate value (x₃,y₃) and the fourth coordinate value (x₄,y₄) indicating two points.

After operation 90, in operation 92, a predetermined control value to correct image alignment errors on a vertical axis by controlling ink ejection is obtained from the second straight line equation.

For example, when y equals 0 so that the alignment errors on the vertical axis do not occur, x corresponding to the predetermined control value from the above-described Equation 7 can be obtained by Equation 8.

x=(x₃×y₄−x₄×y₃)/(y₄−y₃) (8)

In other words, x corresponding to no alignment errors on the vertical axis becomes a predetermined control value for correcting alignment errors on the vertical axis. Specifically, the predetermined control value x can be used to control ink ejection by adjusting a starting point of a printhead, an ink dropping time or selection of nozzles of the printhead.

Hereinafter, an apparatus to correct image alignment errors according to the present invention will be described with reference to the accompanying drawings.

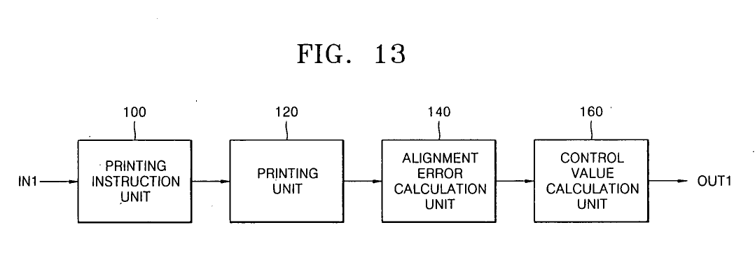

FIG. 13 is a block diagram illustrating a structure of an apparatus for correcting image alignment errors. The apparatus to correct image alignment errors includes a printing instruction unit 100, a printing unit 120, an alignment error calculation unit 140, and a control value calculation unit 160.

The printing instruction unit 100 instructs the printing unit 120 to print a first reference line, a first comparison line, and a second comparison line and outputs an instruction result as an instruction signal. The printing instruction unit 100 instructs the printing unit 120 to print the reference line, the first comparison line, and the second comparison line in response to a control value for correcting alignment errors in an image input through an input terminal IN1 and outputs an instruction result as an instruction signal to the printing unit 120.

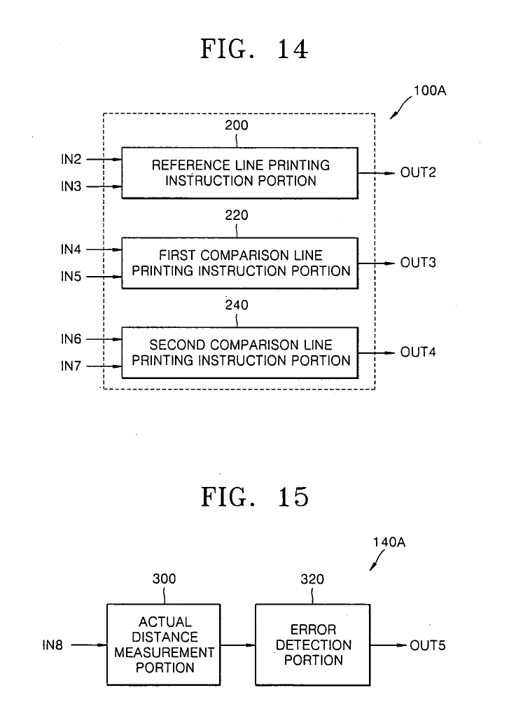

FIG. 14 is a block diagram illustrating the printing instruction unit 100 shown in FIG. 13, according to an embodiment 100A of the present invention. Referring to FIG. 14, the printing instruction unit 100A includes a reference line printing instruction portion 200, a first comparison line printing instruction portion 220, and a second comparison line printing instruction portion 240.

The reference line printing instruction portion 200 instructs the printing unit 120 to print a vertical reference line at a first position on a sheet of paper in response to a first control value used to control ink ejection according to a first printing mode, or instructs the printing unit 120 to print a horizontal reference line at a fourth position on the sheet of paper in response to a fourth control value used to control ink ejection according to a third printing mode and outputs an instruction result as a reference line printing instruction signal. The reference line printing instruction portion 200 instructs the printing unit 120 to print the vertical reference line at the first position on the sheet of paper in response to the first control value input through an input terminal IN2 and outputs an instruction result as a reference line printing instruction signal through an output terminal OUT2 to the printing unit 120. In addition, the reference line printing instruction portion 200 instructs the printing unit 120 to print the horizontal reference line at the fourth position on the sheet of paper in response to the fourth control value input through an input terminal IN3 and outputs an instruction result as a reference line printing instruction signal to the printing unit 120 through the output terminal OUT2.

The first comparison line printing instruction portion 220 instructs the printing unit 120 to print a first vertical comparison line at a second position on the sheet of paper separated from the vertical reference line printed at the first position by a first predetermined distance that is virtually set, in response to a second control value used to control ink ejection according to a second printing mode, or instructs the printing unit 120 to print a first horizontal comparison line at a fifth position of the sheet of paper separated from the horizontal reference line printed at the fourth position by a third predetermined distance that is virtually set, in response to a fifth control value used to control ink ejection according to a fourth printing mode and outputs an instruction result to the printing unit 120 as a first comparison line printing instruction signal.

The first comparison line printing instruction portion 220 instructs the printing unit 120 to print the first vertical comparison line at the second position on the sheet of paper in response to the second control value input through an input terminal IN4 and outputs an instruction result as a first comparison line printing instruction signal to the printing unit 120 through an output terminal OUT3. The second position is separated from the vertical reference line by the first predetermined distance. The first predetermined distance refers to a virtual distance from the vertical reference line assuming that there are no image alignment errors of the ink-jet printer. In addition, the first comparison line printing instruction portion 220 instructs the printing unit 120 to print the first horizontal comparison line at the fifth position of the sheet of paper in response to the fifth control value input through an input terminal IN5 and outputs an instruction result as the first comparison line printing instruction signal to the printing unit 120 through the output terminal OUT3. The fifth position is separated from the horizontal reference line by a third predetermined distance. The third predetermined distance L₃ refers to a virtual distance from the horizontal reference line assuming that there are no image alignment errors of the ink-jet printer.

The first comparison line printing instruction portion 220 instructs the printing unit 120 to print the first vertical comparison line in the same direction as or in a direction opposite to the direction of the vertical reference line, or instructs the printing unit 120 to print the first horizontal comparison line using a different printhead from a printhead used to print the horizontal reference line.

The second comparison line printing instruction portion 240 instructs the printing unit 120 to print a second vertical comparison line at the third position of the sheet of paper separated from the vertical reference line printed at the first position by a second predetermined distance that is virtually set, in response to the third control value used to control ink ejection according to a second printing mode, or instructs the printing unit 120 to print a second horizontal comparison line at a sixth position on the sheet of paper separated from the horizontal reference line printed at the fourth position by a fourth predetermined distance that is virtually set, in response to a sixth control value used to control ink ejection according to a fourth printing mode and outputs an instruction result as a second comparison line printing instruction signal.

The second comparison line printing instruction portion 240 instructs the printing unit 120 to print the second vertical comparison line at the third position on the sheet of paper in response to the third control value input through an input terminal IN6 and outputs an instruction result as a second comparison line printing instruction signal to the printing unit 120 through an output terminal OUT4. The third position is separated from the vertical reference line by the second predetermined distance. The second predetermined distance L₂ refers to a virtual distance from the vertical reference line assuming that there are no image alignment errors of the ink-jet printer. In addition, the second comparison line printing instruction portion 240 instructs the printing unit 120 to print the second horizontal comparison line at the sixth position on the sheet of paper in response to the sixth control value input through an input terminal IN7 and outputs an instruction result as the second comparison line printing instruction signal to the printing unit 120 through the output terminal OUT4. The sixth position is separated from the horizontal reference line by a fourth predetermined distance. The fourth predetermined distance refers to a virtual distance from the horizontal reference line assuming that there are no image alignment errors of the ink-jet printer.

The second comparison line printing instruction portion 240 instructs the printing unit 120 to print the second vertical comparison line in the same direction as or in a direction opposite to the direction of the vertical reference line, or instructs the printing unit 120 to print the second horizontal comparison line using a different printhead from a printhead used to print the horizontal reference line.

Meanwhile, the first comparison line printing instruction portion 220 and the second comparison line printing instruction portion 240 instruct the printing unit 120 to print the first vertical comparison line and the second vertical comparison line together on a left or right side of the vertical reference line or on both left and right sides of the vertical reference line. In addition, the first comparison line printing instruction portion 220 and the second comparison line printing instruction portion 240 instruct the printing unit 120 to print the first horizontal comparison line and the second horizontal comparison line together on an upper or a lower side of the horizontal reference line or on both upper and lower sides of the horizontal reference line.

The printing unit 120 prints the reference line, the first comparison line, and the second comparison line in response to an instruction signal input by the printing instruction unit 100 and outputs a printing result. For example, the printing unit 120 receives a reference line printing instruction signal used to print the horizontal reference line or the vertical reference line, from the reference line printing instruction portion 200 and prints the horizontal reference line or the vertical reference line. In addition, the printing unit 120 receives a first comparison line printing instruction signal used to print the first vertical comparison line or the first horizontal comparison line, from the first comparison line printing instruction portion 220 and prints the first vertical comparison line or the first horizontal comparison line. In addition, the printing unit 120 receives a second comparison line printing instruction signal used to print the second vertical comparison line or the second horizontal comparison line, from the second comparison line printing instruction portion 240 and prints the second vertical comparison line or the second horizontal comparison line.

The alignment error calculation unit 140 calculates alignment errors by measuring a distance between the reference line and the first comparison line and a distance between the reference line and the second comparison line in response to a printing result input by the printing unit 120.

FIG. 15 is a block diagram illustrating the alignment error calculation unit shown in FIG. 13, according to an embodiment 140A of the present invention. The alignment error calculation unit 140A includes an actual distance measurement portion 300 and an error detection portion 320.

The actual distance measurement portion 300 measures a first actual distance between the vertical reference line and the first vertical comparison line and a second actual distance between the vertical reference line and the second vertical comparison line, or measures a third actual distance between the horizontal reference line and the first horizontal comparison line and a fourth actual distance between the horizontal reference line and the fourth horizontal comparison line and outputs a measuring result as an actual distance measuring signal.

The actual distance measurement portion 300 measures the first actual distance between the vertical reference line and the first vertical comparison line and the second actual distance between the vertical reference line and the second vertical comparison line, or measures the third actual distance between the horizontal reference line and the first horizontal comparison line and the fourth actual distance between the horizontal reference line and the second horizontal comparison line in response to a printing result input by the printing unit 120 through an input terminal IN8 and outputs a measuring result to the error detection portion 320.

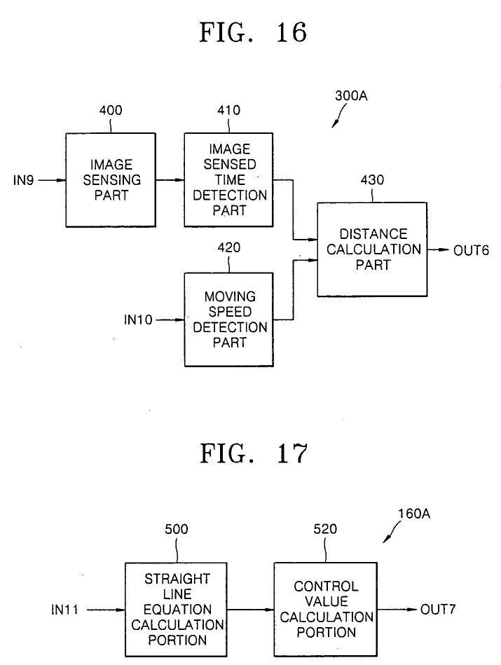

FIG. 16 is a block diagram illustrating the actual distance measurement portion 300 shown in FIG. 15, according to an embodiment 300A of the present invention. The actual distance measurement portion 300A includes an image sensing part 400, an image sensed time detection part 410, a moving speed detection part 420, and a distance calculation part 430.

The image sensing part 400 senses a vertical reference line, a first vertical comparison line, a second vertical comparison line, a horizontal reference line, a first horizontal comparison line, and a second horizontal comparison line and outputs a sensing result. The image sensing part 400 senses the vertical reference line, the first vertical comparison line, and the second vertical comparison line, or senses the horizontal reference line, the first horizontal comparison line, and the second horizontal comparison line in response to a printing result input by the printing unit 120 through an input terminal IN9 and outputs a sensing result to the image sensed time detection part 410.

The image sensed time detection part 410 detects sensing times of the sensing result of the image sensing part 400 and outputs detected times. The image sensed time detection part 410 receives a reference clock signal generated by a reference clock generation unit (not shown), detects a time when the vertical reference line, the first vertical comparison line, and the second vertical comparison, or the horizontal reference line, the first horizontal comparison line, and the second horizontal comparison line are sensed by the image sensing part 400. The image sensed time detection part 410 outputs each detected sensing time to the distance calculation part 430. For example, the image sensed time detection part 410 detects a time t₁ when the first vertical comparison line is sensed, a time t₂ when the vertical reference line is sensed, and a time t₃ when the second vertical comparison line is sensed, and outputs each detected sensing time to the distance calculation part 430, or detects a time t₄ when the first horizontal comparison line is sensed, a time t₅ when the horizontal reference line is sensed, and a time t₆ when the second horizontal comparison line is sensed, and outputs each detected sensing time to the distance calculation part 430.

The moving speed detection part 420 detects a moving speed on a horizontal axis or a vertical axis of the printhead and outputs the detected moving speed. The moving speed detection part 420 detects the moving speed on the horizontal axis or the vertical axis of the printhead input through an input terminal IN10 and outputs the detected moving speed on the horizontal axis or the vertical axis of the printhead to the distance calculation part 430. The moving speed of the printhead may be constant or varied. If the moving speed of the printhead is constant, the constant moving speed is detected. However, if the moving speed of the printhead is varied, the moving speed obtained by integrating a varied speed in a predetermined section is detected.

The distance calculation part 430 calculates a first actual distance by multiplying a time difference between the time when the sensed vertical reference line is detected and the time when the first sensed vertical comparison line is detected, by the detected moving speed on the horizontal axis and calculates a second actual distance by multiplying a time difference between the time when the sensed vertical reference line is detected and the time when the second sensed vertical comparison line is detected, by the detected moving speed on the horizontal axis, or calculates a third actual distance by multiplying a time difference between the time when the sensed horizontal reference line is detected and the time when the first sensed horizontal comparison line is detected, by the detected moving speed on the vertical axis and calculates a fourth actual distance by multiplying a time difference between the time when the sensed horizontal reference line is detected and the time when the second sensed horizontal comparison line is detected, by the detected moving speed on the vertical axis and outputs a calculation result.

For example, the distance calculation part 430 obtains a time difference T₁ between the time t₂ when the vertical reference line input by the image sensed time detection part 410 is sensed and the time t₁ when the first vertical comparison line is sensed, and calculates a first actual distance expressed as T₁×v₁ by multiplying the obtained time difference T₁ by a moving speed v₁ on the horizontal axis of the printhead input by the moving speed detection part 420. The distance calculation part 430 outputs the first calculated actual distance through an output terminal OUT6. In addition, the distance calculation part 430 obtains a time difference T₂ between the time t₂ when the vertical reference line input by the image sensed time detection part 410 is sensed and the time t₃ when the second vertical comparison line is sensed, and calculates a second actual distance expressed as T₂×v₁ by multiplying the obtained time difference T₂ by a moving speed v₁ on the horizontal axis of the printhead input by the moving speed detection part 420. The distance calculation part 430 outputs the second calculated actual distance through the output terminal OUT6. In addition, the distance calculation part 430 obtains a time difference T₃ between the time t₅ when the horizontal reference line input by the image sensed time detection part 410 is sensed and the time t₄ when the first horizontal comparison line is sensed, and calculates a third actual distance expressed as T₃×v₂ by multiplying the obtained time difference T₃ by a moving speed v₂ on the vertical axis of the printhead input by the moving speed detection part 420. The distance calculation part 430 outputs the third calculated actual distance through the output terminal OUT6. In addition, the distance calculation part 430 obtains a time difference T₄ between the time t₅ when the horizontal reference line input by the image sensed time detection part 410 is sensed and the time t₆ when the second horizontal comparison line is sensed, and calculates a fourth actual distance expressed as T₄×v₂ by multiplying the obtained time difference T₄ by the moving speed v₂ on the vertical axis of the printhead input by the moving speed detection part 420. The distance calculation part 430 outputs the fourth calculated actual distance through the output terminal OUT6.

The error detection portion 320 obtains first alignment errors on the horizontal axis by subtracting a first predetermined distance from the first actual distance and obtains second alignment errors on the horizontal axis by subtracting a second predetermined distance from the second actual distance, or obtains first alignment errors on the vertical axis by subtracting a third predetermined distance from the third actual distance and obtains second alignment errors on the vertical axis by subtracting a fourth predetermined distance from the fourth actual distance and outputs obtained alignment errors. The error detection portion 320 stores information on the first predetermined distance, the second predetermined distance, the third predetermined distance, and the fourth predetermined distance in advance and uses the information when detecting the first alignment errors on the horizontal axis, the second alignment errors on the horizontal axis, the first alignment errors on the vertical axis, and the second alignment errors on the vertical axis.

The error detection portion 320 obtains the first alignment errors on the horizontal axis by subtracting the first predetermined distance from the first actual distance, in response to the first actual distance input by the actual distance measurement unit 300. In addition, the error detection portion 320 obtains the second alignment errors on the horizontal axis by subtracting the second predetermined distance from the second actual distance, in response to the second actual distance input by the actual distance measurement unit 300 and outputs an obtained result to the control value calculation unit 160 through an output terminal OUT5. In addition, the error detection portion 320 obtains the first alignment errors on the vertical axis by subtracting the third predetermined distance from the third actual distance, in response to the third actual distance input by the actual distance measurement unit 300 and outputs an obtained result to the control value calculation unit 160 through the output terminal OUT5. In addition, the error detection portion 320 obtains the second alignment errors on the vertical axis by subtracting the fourth predetermined distance from the fourth actual distance, in response to the fourth actual distance input by the actual distance measurement unit 300 and outputs an obtained result to the control value calculation unit 160 through the output terminal OUT5.

The control value calculation unit 160 calculates a predetermined control value for correcting alignment errors in response to the alignment errors input by the alignment error calculation unit 140 and outputs a calculation result through an output terminal OUT1.

FIG. 17 is a block diagram illustrating the control value calculation unit 160 shown in FIG. 13, according to an embodiment of the present invention. Referring to FIG. 17, the control value calculation unit 160A includes a straight line equation calculation portion 500 and a control value calculation portion 520.

The straight line equation calculation portion 500 obtains a first straight line equation in which a second control value and first alignment error on a horizontal axis are used as a first coordinate value (second control value, first alignment error on the horizontal axis) and a third control value and second alignment error on the horizontal axis are used as a second coordinate value (third control value, second alignment error on the horizontal axis), or obtains a second straight line equation in which a fifth control value and first alignment error on a vertical axis are used as a third coordinate value (fifth control value, first alignment error on the vertical axis) and a sixth control value and second alignment error on the vertical axis are used as a fourth coordinate value (sixth control value, second alignment error on the vertical axis), and outputs an obtained result of the straight line equations.

For example, assuming that the second control value is x₁, the first alignment error on the horizontal axis is y₁, the third control value is x₂ and the second alignment error on the horizontal axis is y₂ , the first straight line equation can be obtained by Equation 5. In other words, the straight line equation calculation portion 500 receives y₁ corresponding to the first alignment error on the horizontal axis and y₂ corresponding to the second alignment error on the horizontal axis from the alignment error calculation unit 140 and obtains the first straight line equation shown in Equation 5, in which x₁ corresponding to the second control value and y₁ corresponding to the first input alignment error on the horizontal axis are used as the first coordinate value (x₁,y₁) and x₂ corresponding to the third control value and y₂ corresponding to the second input alignment error on the horizontal axis are used as the second coordinate value (x₂,y₂), and outputs the first obtained straight line equation to the control value calculation portion 520.

In addition, assuming that the fifth control value is x₃, the first alignment error on the vertical axis is y₃, the sixth control value is x₄ and the second alignment error on the vertical axis is y₄, the second straight line equation can be obtained by Equation 7. In other words, the straight line equation calculation portion 500 receives y₃ corresponding to the first alignment error on the vertical axis and y₄ corresponding to the second alignment error on the vertical axis from the alignment error calculation unit 140 and obtains the second straight line equation shown in Equation 7, in which x₃ corresponding to the fifth control value and y₃ corresponding to the first input alignment error on the vertical axis are used as the third coordinate value (x₃,y₃) and x₅ corresponding to the sixth control value and y₄ corresponding to the second input alignment error on the vertical axis are used as the fourth coordinate value (x₅,y₄), and outputs the second obtained straight line equation to the control value calculation portion 520.

The control value calculation portion 520 obtains a predetermined control value for correcting alignment errors on the horizontal axis from the first straight line equation, or obtains a predetermined control value for correcting alignment errors on the vertical axis from the second straight line equation, and outputs an obtained predetermined control value.

For example, x corresponding to the predetermined control value in which ‘0’ is used as y so that alignment errors on the horizontal axis do not occur from the above-described Equation 5, can be obtained by Equation 6. In other words, the control value calculation portion 520 obtains x shown in Equation 6, when there are no alignment errors on the horizontal axis (y=0), from the first straight line equation and outputs x corresponding to the obtained predetermined control value through an output terminal OUT7. In addition, x corresponding to the predetermined control value when y=0 so that the alignment errors on the vertical axis do not occur from the above-described Equation 7, can be obtained by Equation 8. In other words, the control value calculation portion 520 obtains x shown in Equation 8, when there are no alignment errors on the vertical axis, from the second straight line equation and outputs x corresponding to the obtained predetermined control value through the output terminal OUT7.

The output predetermined control value is a variable for correcting alignment errors on the horizontal axis or the vertical axis and is used to control ink ejection according to a variety of printing modes by adjusting a starting point of a printhead, an ink dropping time or selection of nozzles of the printhead.

As described above, in the method of and apparatus for correcting image alignment errors according to the present invention, even though a user does not check the alignment of a plurality of test marks, as a premise for correcting image alignment with the naked eye, errors in image alignment can be conveniently measured using only three test marks, and a control value used to correct the measured alignment errors can be easily obtained, such that image alignment errors are automatically corrected.

In addition, in the method of and apparatus for correcting image alignment errors according to the present invention, by using three test marks, alignment errors can be measured even in a smaller area than the area occupied by a plurality of test marks, such that proper compensation of image alignment errors is performed at a local position.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of correcting image alignment errors in an ink-jet printer which has a printhead and performs a printing operation by ejecting ink from the printhead according to a variety of printing modes, the method comprising:
printing a reference line, a first comparison line, and a second comparison line;
calculating image alignment errors by measuring a first distance between the reference line and the first comparison line and a second distance between the reference line and the second comparison line; and
calculating a predetermined control value correcting the calculated image alignment errors; wherein the image alignment errors are corrected by controlling ink ejection using the calculated predetermined control value.

2. The method of claim 1, wherein the printing the reference line, the first comparison line, and the second comparison line comprises:
printing a vertical reference line at a first position on a sheet of paper by a first control value used to control ink ejection according to a first printing mode;
printing a first vertical comparison line at a second position on the sheet of paper separated from the vertical reference line printed at the first position by a first predetermined distance, by a second control value used to control ink ejection according to a second printing mode; and
printing a second vertical comparison line at a third position on the sheet of paper separated from the vertical reference line printed at the first position by a second predetermined distance, by a third control value used to control ink ejection according to the second printing mode.

3. The method of claim 2, wherein the first vertical comparison line and the second vertical comparison line are printed in the same direction as or in a direction opposite to the direction of the vertical reference line.

4. The method of claim 2, wherein the first vertical comparison line and the second vertical comparison line are printed on one side of the vertical reference line.

5. The method of claim 2, wherein the first vertical comparison line and the second vertical comparison line are printed on both sides of the vertical reference line.

6. The method of claim 2, wherein the calculating image alignment errors by measuring the first distance and the second distance comprises:
measuring a first actual distance between the vertical reference line and the first vertical comparison line and a second actual distance between the vertical reference line and the second vertical comparison line; and
obtaining a first alignment error on a horizontal axis by subtracting the first predetermined distance from the first actual distance and obtaining a second alignment error on the horizontal axis by subtracting the second predetermined distance from the second actual distance.

7. The method of claim 6, wherein the measuring the first and second actual distances comprises:
sensing the vertical reference line, the first vertical comparison line, and the second vertical comparison line and detecting corresponding times where the vertical reference line, the first vertical comparison line, and the second vertical comparison line are sensed; and
calculating the first actual distance by multiplying a time difference between the time when the sensed vertical reference line is detected and the time when the first sensed vertical comparison line is detected, by a moving speed on the horizontal axis of the printhead, and calculating the second actual distance by multiplying a time difference between the time when the sensed vertical reference line is detected and the time when the second sensed vertical comparison line is detected, by the moving speed on the horizontal axis of the printhead.

8. The method of claim 6, wherein the calculating the predetermined control value comprises:
obtaining a first straight line equation in which the second control value and the first alignment error on the horizontal axis are used as a first coordinate value and the third control value and the second alignment error on the horizontal axis are used as a second coordinate value; and
obtaining the predetermined control value correcting alignment errors on the horizontal axis from the first straight line equation.

9. The method of claim 8, wherein, the first straight line equation is obtained using the following Equation:
y=(y₂−y₁) (x−x₁)/(x₂−x₁)+y₁=(y₂−y₁) (x−x₂)/(x₂−x₁)+y₂
where x is the predetermined control value, y are alignment errors on the horizontal axis according to a variation of the predetermined control value, x₁ is the second control value, x₂ is the third control value, y₁ is the first alignment error on the horizontal axis, and y₂ is the second alignment error on the horizontal axis.

10. The method of claim 9, wherein x, corresponding to the predetermined control value when y equals 0 so that the alignment errors on the horizontal axis do not occur, is obtained using the following Equation:
x=(x₁×y₂−x₂×y₁) (y₂−y₁)

11. The method of claim 1, wherein the printing the reference line, the first comparison line, and the second comparison line comprises:
printing a horizontal reference line at a fourth position on a sheet of paper by a fourth control value used to control ink ejection according to a third printing mode;
printing a first horizontal comparison line at a fifth position on the sheet of paper separated from the horizontal reference line printed at the fourth position by a third predetermined distance that is virtually set, by a fifth control value used to control ink ejection according to a fourth printing mode; and
printing a second horizontal comparison line at a sixth position on the sheet of paper separated from the horizontal reference line printed at the fourth position by a fourth predetermined distance that is virtually set, by a sixth control value used to control ink ejection according to the fourth printing mode.

12. The method of claim 11, wherein the first horizontal comparison line and the second horizontal comparison line are printed using a different printhead from a printhead for printing the horizontal reference line.

13. The method of claim 11, wherein the first horizontal comparison line and the second horizontal comparison line are printed on one side of the horizontal reference line.

14. The method of claim 11, wherein the first horizontal comparison line and the second horizontal comparison line are printed on both sides of the horizontal reference line.

15. The method of claim 11, wherein the calculating image alignment errors by measuring the first distance and the second distance comprises:
measuring a third actual distance between the horizontal reference line and the first horizontal comparison line and a fourth actual distance between the horizontal reference line and the second horizontal comparison line; and
obtaining first alignment errors on a vertical axis by subtracting the third predetermined distance from the third actual distance and obtaining second alignment errors on the vertical axis by subtracting the fourth predetermined distance from the fourth actual distance.

16. The method of claim 15, wherein the measuring the third and fourth actual distances comprises:
sensing the horizontal reference line, the first horizontal comparison line, and the second horizontal comparison line and detecting corresponding times when the horizontal reference line, the first horizontal comparison line, and the second horizontal comparison line are sensed; and
calculating the third actual distance by multiplying a time difference between the time when the sensed horizontal reference line is detected and the time when the first sensed horizontal comparison line is detected, by a moving speed on the vertical axis of the printhead, and calculating the fourth actual distance by multiplying a time difference between the time when the sensed horizontal reference line is detected and the time when the second sensed horizontal comparison line is detected, by the moving speed on the vertical axis of the printhead.

17. The method of claim 15, wherein the calculating the predetermined control value comprises:
obtaining a second straight line equation in which the fifth control value and the first alignment error on the vertical axis are used as a third coordinate value and the sixth control value and the second alignment error on the vertical axis are used as a fourth coordinate value; and
obtaining the predetermined control value for correcting alignment errors on the vertical axis from the second straight line equation.

18. The method of claim 17, wherein the second straight line equation is obtained using the following Equation:
y=(y₄−y₃) (x−x₃)/(x₄−x₃)+y₃=(y₄−y₃) (x−x₄)/(x₄−x₃)+y₄
where x is the predetermined control value, y are alignment errors on the vertical axis according to a variation of the predetermined control value, x₃ is the fifth control value, x₄ is the sixth control value, y₃ is the first alignment error on the vertical axis, and y₄ is the second alignment error on the vertical axis.

19. The method of claim 18, wherein x, corresponding to the predetermined control value when y equals 0 so that the alignment errors on the vertical axis do not occur, is obtained using the following Equation:
x=(x₃×y₄−x₄×y₃)/(y₄−y₃).

20. The method of claim 1, wherein ink ejection is controlled by adjusting a starting point of the printhead, an ink dropping time or selection of nozzles of the printhead.

21. An apparatus for correcting image alignment errors in an ink-jet printer which has a printhead and performs a printing operation by ejecting ink from the printhead according to a variety of printing modes, the apparatus comprising:
a printing instruction unit, which outputs an instruction signal to print a first reference line, a first comparison line, and a second comparison line;
a printing unit, which prints the reference line, the first comparison line, and the second comparison line in response to the instruction signal;
an alignment error calculation unit, which calculates alignment errors by measuring a distance between the reference line and the first comparison line and a distance between the reference line and the second comparison line; and
a control value calculation unit, which calculates a predetermined control value for correcting the calculated image alignment errors, wherein the image alignment errors are corrected by controlling ink ejection using the calculated predetermined control value.

22. The apparatus of claim 21, wherein the printing instruction unit comprises:
a reference line printing instruction portion which outputs an instruction signal to print a vertical reference line at a first position on a sheet of paper in response to a first control value used to control ink ejection according to a first printing mode, or outputs the instruction signal to print a horizontal reference line at a fourth position on the sheet of paper in response to a fourth control value used to control ink ejection according to a third printing mode;
a first comparison line printing instruction portion which outputs a first comparison line printing instruction signal to print a first vertical comparison line at a second position on the sheet of paper separated from the vertical reference line printed at the first position by a first predetermined distance, in response to a second control value used to control ink ejection according to a second printing mode, or outputs the first comparison line printing instruction signal to print a first horizontal comparison line at a fifth position of the sheet of paper separated from the horizontal reference line printed at the fourth position by a third predetermined distance, in response to a fifth control value used to control ink ejection according to a fourth printing mode; and
a second comparison line printing instruction portion, which first comparison line printing to print a second vertical comparison line at the third position on the sheet of paper separated from the vertical reference line printed at the first position by a second predetermined distance that is virtually set, in response to a third control value used to control ink ejection according to the second printing mode, or instructs to print a second horizontal comparison line at a sixth position of the sheet of paper separated from the horizontal reference line printed at the fourth position by a fourth predetermined distance that is virtually set, in response to a sixth control value used to control ink ejection according to the fourth printing mode and outputs an instruction result as a second comparison line printing instruction signal.

23. The apparatus of claim 22, wherein the alignment error calculation unit comprises:
an actual distance measurement portion, which measures a first actual distance between the vertical reference line and the first vertical comparison line and a second actual distance between the vertical reference line and the second vertical comparison line, or measures a third actual distance between the horizontal reference line and the first horizontal comparison line and a fourth actual distance between the horizontal reference line and the fourth horizontal comparison line and outputs a measuring result as an actual distance measurement signal; and
an error detection portion, which obtains first alignment errors on the horizontal axis by subtracting the first predetermined distance from the first actual distance and obtains second alignment errors on the horizontal axis by subtracting the second predetermined distance from the second actual distance, or obtains first alignment errors on the vertical axis by subtracting the third predetermined distance from the third actual distance and obtains second alignment errors on the vertical axis by subtracting the fourth predetermined distance from the fourth actual distance and outputs obtained alignment errors.

24. The apparatus of claim 23, wherein the actual distance measurement unit comprises:
an image sensing part, which senses the vertical reference line, the first vertical comparison line, the second vertical comparison line, the horizontal reference line, the first horizontal comparison line, and the second horizontal comparison line and outputs a corresponding sensing result;
an image sensed time detection part, which detects sensing times of the corresponding sensing result of the image sensing part and outputs detected times;
a moving speed detection part, which detects a moving speed on a horizontal axis or a vertical axis of the printhead and outputs the detected moving speed; and
a distance calculation part, which calculates the first actual distance by multiplying a time difference between a time when the sensed vertical reference line is detected and a time when the first sensed vertical comparison line is detected, by the detected moving speed on the horizontal axis, and calculates the second actual distance by multiplying a time difference between a time when the sensed vertical reference line is detected and a time when the second sensed vertical comparison line is detected, by the detected moving speed on the horizontal axis, or calculates the third actual distance by multiplying a time difference between a time when the sensed horizontal reference line is detected and a time when the first sensed horizontal comparison line is detected, by the detected moving speed on the vertical axis, and calculates the fourth actual distance by multiplying a time difference between a time when the sensed horizontal reference line is detected and a time when the second sensed horizontal comparison line is detected, by the detected moving speed on the vertical axis and outputs a calculation result.

25. The apparatus of claim 24, wherein the control value calculation unit comprises:
a straight line equation calculation portion, which obtains a first straight line equation in which the second control value and first alignment error on the horizontal axis are used as a first coordinate value and the third control value and second alignment error on the horizontal axis are used as a second coordinate value, or obtains a second straight line equation in which the fifth control value and first alignment error on a vertical axis are used as a third coordinate value and the sixth control value and second alignment error on the vertical axis are used as a fourth coordinate value; and
a control value calculation portion, which obtains a predetermined control value correcting alignment errors on the horizontal axis from the first straight line equation, or obtains a predetermined control value correcting alignment errors on the vertical axis from the second straight line equation, and outputs an obtained predetermined control value.

26. An image alignment error correcting method comprising:
printing a reference line;
printing a first comparison line a first predetermined distance from the printed reference line;
printing a second comparison line a second predetermined distance from the printed reference line;
determining a first actual distance between the printed reference line and the printed first comparison line;
determining a second actual distance between the printed reference line and the printed second comparison line;
determining image alignment errors based upon a difference between the first predetermined distance and the first actual distance and a difference between the second predetermined distance and the second actual distance; and
determining a correcting control value to correct for the image alignment error, based on the determined image alignment errors.

27. The method of claim 26, wherein the reference line, the first comparison line, and the second comparison line are vertically oriented.

28. The method of claim 26, wherein the reference line, the first comparison line, and the second comparison line are horizontally oriented.

29. The method of claim 26, wherein only one reference line, one first comparison line and one second comparison line are printed.

30. The method of claim 26, wherein the determining the first actual distance between the printed reference line and the printed first comparison line comprises:
determining a time difference of a printhead moving at a predetermined speed between the printed first comparison line and the printed reference line;
calculating the first actual distance based on the predetermined moving speed and the time difference.

31. The method of claim 30, wherein the determining the second actual distance between the printed reference line and the printed second comparison line comprises:
determining a time difference of a printhead moving at a predetermined speed between the printed second comparison line and the printed reference line; and
calculating the second actual distance based on the predetermined moving speed and the time difference.

32. An image alignment calibration device comprising:
a printing unit;
a controller to output signals to the printing unit to print a reference line at a first predetermined position, to print a first comparison line a first predetermined distance from the reference line and to print a second comparison line a second predetermined distance from the reference line in response to an image alignment correction request signal;
a distance determiner to determine a first actual distance between the printed first comparison line and the printed reference line and a second actual distance between the printed second comparison line and the printed reference line;
an error detector which outputs a first alignment error based on the difference between the first predetermined distance and the first actual distance and a second alignment error based on the difference between the second predetermined distance and the second actual distance; and
a control value calculator which calculates an image correcting control value based on the first alignment error and the second alignment error.

33. The device of claim 32, wherein the reference line, the first comparison line, and the second comparison line are vertically oriented.

34. The device of claim 32, wherein the reference line, the first comparison line, and the second comparison line are horizontally oriented.

35. The device of claim 32, wherein only one reference line, one first comparison line and one second comparison line are printed.

36. An image alignment error correcting method comprising:
determining image alignment errors based upon a difference between predetermined distances which correspond to spaces between three printed test marks and actual distances between the three test marks, respectively; and
determining a correcting control value to automatically correct for the image alignment errors, based on the determined image alignment errors.
